(19) United States
(12) Patent Application Publication
(10) Pub. No.: US 2020/0217275 A1
(43) Pub. Date: Jul. 9, 2020

(54) Filter Medium and Production Method, Filter Element, Use of the Filter Element, and Water Injection System

(71) Applicant: MANN+HUMMEL GmbH, Ludwigsburg (DE)

(72) Inventors: Jochen Krauss, Besigheim (DE); Christine Oprisch, Oberriexingen (DE); Heiko Wyhler, Stuttgart (DE)

(21) Appl. No.: 16/734,490

(22) Filed: Jan. 6, 2020

Related U.S. Application Data
(63) Continuation of application No. PCT/EP2018/065454, filed on Jun. 12, 2018.

(30) Foreign Application Priority Data
Jul. 7, 2017 (DE) 10 2017 006 462.8

(51) Int. Cl. F02M 25/022; B01D 39/16; B01D 46/00; B01D 46/10; B01D 46/52; C02F 1/00; C02F 1/50; F02M 25/025; A01N 25/34; A01N 55/02

(52) U.S. Cl. CPC F02M 25/0224; C02F 2103/02; B01D 46/0001; B01D 46/0028; B01D 46/10; B01D 46/521; C02F 1/004; C02F 1/505; F02M 25/0222; F02M 25/025; A01N 25/34; A01N 55/02; B01D 2239/0442; B01D 2239/0622; B01D 2239/1258; B01D 2239/0654; B01D 2275/10; C02F 2303/04; B01D 39/1623

(57) ABSTRACT

A filter medium is provided with a first layer as a support layer and a second layer as a filtration layer arranged downstream of the first layer. The first layer and the second layer both are provided with at least one active agent that is at least antibacterial. The active agent can be applied as a coating or as an impregnation. Examples of active agents are pyrithione, a metal salt of pyrithione, a pyrithione derivative, a metal salt of a pyrithione derivative, and a quaternary ammonium salt. A filter element is provided with such a filter medium in the form of a filter media pack. The filter medium and filter element can be used in a water injection system for internal combustion engines.

### CROSS-REFERENCE TO RELATED APPLICATIONS

This application is a continuation application of international application No. PCT/EP2018/065454 having an international filing date of 12 Jun. 2018 and designating the United States, the international application claiming a priority date of 7 Jul. 2017 based on prior filed German patent application No. 10 2017 006 462.8, the entire contents of the aforesaid international application and the aforesaid German patent application being incorporated herein by reference.

### BACKGROUND OF THE INVENTION

The invention concerns a filter medium, in particular for filtration of water, comprising at least a first layer as a support layer and a second layer as a filtration layer arranged downstream of the first layer; a filter element; a use of the filter element; a method for producing the filter medium; and a water injection system.

DE 10 2011 104 628 A1 discloses a filter medium that comprises at least two filtration layers of which one is furnished with an antimicrobial agent, for example, with zinc pyrithione or with silver, in particular nanosilver, or with other metals. The second filter layer can be in particular a filter layer arranged at the outflow side.

DE 10 2013 021 071 A1 discloses a filter medium for filtration of air in a cabin filter of a motor vehicle. This filter medium comprises a multi-layer construction that comprises at least one anti-allergenic filter layer, a particle filter layer, one or more adsorption layers with active carbon, as well as an antibacterial filter layer that contains zinc pyrithione as active agent.

To begin with, due to its structure that is tailored completely to the relatively small fan output and differential pressures in automotive venting devices, the above described filter medium of the prior art is not suitable for use in liquid systems in which the filter medium is generally exposed to a significantly higher differential pressure. A cabin filter medium is mechanically not so loadable that it could be used also for liquid systems. Moreover, the antimicrobial properties of the cabin filter medium are also insufficient for liquid systems because the germ growth in water in case of standstill for several days and temperatures in the summer of more than 60° in the region of the engine compartment is significantly higher than in the region of an air channel of the venting device. The aforementioned type of antibacterial action may be sufficient for air filters for the cabin region but is not suitable for liquid systems.

### SUMMARY OF THE INVENTION

Based on this prior art, it is now the object of the present invention to provide a filter medium which also provides a satisfactory result with regard to inhibition of germ growth and fulfills the increased requirements with regard to the differential pressure resistance in the field of water filtration.

The invention solves this object by a filter medium characterized in that the first layer as well as the second layer comprise at least an active agent that is at least antibacterial.

The filter medium according to the invention can be used for filtration of water, for example, in a filter element as it is used in a water injection system for internal combustion engines. Such systems comprise in general a water tank, a pump, one or a plurality of filters, a control system, fluid conduits, and injection valves or nozzles. As in all systems in which water is standing for an extended period of time or is exposed to higher temperatures that promote bacterial and fungal growth, there is in this context the risk of a biofilm formation which in particular can lead to the filter element becoming clogged so that it can no longer be flowed through and the water injection system thereby no longer being able to fulfill its function. This must be prevented.

A corresponding filter medium comprises at least a first layer as a support layer and a second layer is a filtration layer arranged downstream relative to the first layer. In this context, the second layer can have a higher dust absorption capacity, in particular a dust absorption capacity that is at least two times higher than that of the first layer. As a support layer, in addition to nonwovens (meltblown, spunbond and the like) also close-mesh screen fabrics or mesh can be used that are in particular comprised of plastic materials. These screen fabrics or mesh can be furnished equally well with the antimicrobial agent.

In this way, allover growth of microorganisms, in particular bacteria, i.e., biofilm formation through all filter layers, can be effectively avoided.

According to the invention, the first layer as well as the second layer comprise at least one at least antibacterial agent. Antibacterial in this context means bacteriostatic properties as well as bactericidal properties.

Advantageously, the active agent not only can be effective against bacteria but also can comprise a bacteriostatic and/or bactericidal as well as fungistatic and/or fungicidal action.

Bactericidal means an action that kills bacteria. In this context, the bacteria must be killed to a certain proportion, preferably at least 99% within the first 4 hours after its application. In comparison to this, bacteriostatic substances only have a growth-inhibiting action.

Moreover, the active agent can be an active agent of the group comprising pyrithione and/or a metal salt thereof, wherein the metal salt is in particular alkali metal salt, in particular a sodium salt, an alkaline earth metal salt or a transition metal salt, preferably of the group zinc, manganese, copper, and iron, or a pyrithione derivative and/or a metal salt thereof, wherein the metal salt is in particular an alkali metal salt, in particular a sodium salt, an alkaline earth metal salt or a transition metal salt, preferably from the group zinc, manganese, copper, and iron. Alternatively or additionally, a quaternary ammonium salt of the general formula NR₄⁺X⁻ or R═NR₂⁺X⁻, wherein R denotes herein an organic residue and wherein R can be the same or different, and wherein R is preferably at least one alkoxy group of the general formula —OCH₃, a siloxy group of the general formula R₃Si—O— or an alkoxysilyl group of the general formula R¹R²R³Si—O—R⁴, in particular a trialkoxysilylpropyl group, and wherein X⁻ is an anion, in particular a halide of the group F, Cl, Br or I.

The pyrithione metal salt or pyrithione derivative metal salt can be a zinc salt, in particular zinc pyrithione.

Furthermore, it can be provided that the quaternary ammonium salt comprises a trialkoxysilylpropyl group, in particular is dimethyltetradecyl [3-(trimethoxsilyl)propyl] ammonium chloride or 3-(tri-methoxysilyl) propyldimethyl octadecyl ammonium chloride.

Furnishing a plurality of layers, i.e., particularly also the support layer, with the at least antibacterial agent is initially more of a disadvantage with regard to manufacturing technology compared to a purely superficial coating. By furnishing a plurality of layers with the at least antibacterial agent, it is however possible to reduce or prevent a bacterial growth at the clean side as well as at the raw side of the filter medium and across all layers. Moreover, it is advantageous when the filter medium across its entire thickness comprises the at least one at least antibacterial active agent. A filter medium that is only antibacterially coated at the surface, as e.g. a cabin filter medium, cannot fulfill the requirements in a water system because a bacterial/fungal growth which may cause blocking is a threat even in an interior of the filter medium or at the layer boundaries. By a configuration with support layer, an improved pressure resistance is advantageously achieved.

The first layer and the second layer can each be provided with an active agent-containing impregnation and/or an active agent-containing coating. By means of the impregnation and/or coating, a more homogenous distribution of the active agent, in particular of the zinc pyrithione, can be achieved moreover across the entire filter plane of the layer.

The active agent-containing coating and/or impregnation can comprise a binding agent based on polyacrylate. Particularly preferred, the binding agent can be a so-called hydrophobically modified polyacrylate (HASE) or a polyacrylate which is cross-linked with polyurethane to a hybrid polymer.

Depending on the layer thickness of the coating, the active agent-containing, in particular zinc pyrithione-containing, polyacrylate coating enables a slow leaching of parts of the zinc pyrithione molecules so that the coating exhibits a depot effect. This is in particular advantageous when the filter medium is used in a filter element of a water injection system because in this way, in case of a back flushing process, also components of the hydraulic system which are spatially greatly separated from the filter element, for example, a pump, can be reached with an at least antibacterial action.

The second layer can be embodied as a nonwoven layer wherein this nonwoven layer comprises at least to 80 wt.-% synthetic fibers, in particular copolymer fibers, PET fibers, PBT fibers, PA fibers and/or PP fibers and/or PE fibers. The fibers can be advantageously meltblown and/or staple fibers.

The air permeability of the filter medium with the coating or impregnation can amount to 100 to 850 l/m²s, preferably 180-700 l/m²s. Appropriate conclusions can be drawn in regard to the permeabilities relative to other media, in particular water. The aforementioned values of the air permeability are to be understood in view of the background of ISO 9237 according to which a differential pressure of 200 Pa is to be applied for the measurement.

The first layer which is embodied as a support layer can comprise in particular a mesh structure, preferably with a thickness of less than 0.8 mm. Still smaller thicknesses are possible wherein a minimum thickness is affected by the strength properties of the material used for the mesh. The first layer which is embodied as a mesh structure serves for mechanical stabilization of the second layer, which is important primarily when the second layer is a nonwoven layer, and has a drainage function. The first layer can comprise at least 80 wt.-% of synthetic fibers, in particular copolymer fibers, PET fibers, PBT fibers, PA fibers and/or PP fibers and/or PE fibers.

In a particularly advantageous embodiment of the invention, the filter medium can comprise, in addition to the at least two aforementioned layers, at least a third layer, in particular a spunbond layer which is embodied at the outflow side relative to the second layer, wherein the third layer is embodied as a support layer.

The third layer can be embodied in particular with a reduced dust absorption capacity compared to the second layer, in particular with a dust absorption capacity that is at least two times smaller. According to this embodiment, the second layer which is embodied as a filtration layer is received essentially sandwiched between the two support layers, first layer and third layer. This has the advantage that the filtration layer can be supported optimally in both possible flow directions. In use of the filter medium in a filter element of a water injection system, this is advantageous because a reversal of the flow direction may occur for back flushing of system components such as the injection nozzles/valves and/or the pump.

Particularly preferred, each layer of the filter medium now comprises an active agent-containing impregnation and/or an active agent-containing coating. This is in particular advantageous in order to ensure that no germ contamination will build up in intermediate layers or support layers at the clean side or raw side. Most preferred, each layer of the filter medium, the two, three or even more layers, are furnished individually with the active agent. In this context, the layers each can also be penetrated by the active agent.

The ratio between the concentration of zinc pyrithione and the concentration of binding agent in the impregnation and/or coating can therefore be adjusted by a laboratory technician or an engineer for paints and varnishes by routine work such that at least 0.1 wt.-% of zinc pyrithione after 168 h in water at 65° C. can be washed out from the coating and/or the impregnation.

According to a further embodiment, the first layer can have a reduced thickness compared to the second layer, in particular a thickness reduced by at least 1.5 times. In this way, despite the coating and a possibly entailed fiber cross section enlargement for the layer, a certain bulkiness can be achieved that is important for a high dust absorption capacity.

The second layer which is embodied as a filtration layer is to be selected in this context such that also dust particles or microbes with a size of 10 μm can be retained quantitatively, i.e., to more than 95%, in particular more than 99%. A corresponding specification with regard to the size of the dust particles to be filtered is indicated in the product datasheet for most commercially obtainable filter media.

The first layer can have a reduced weight per surface area in comparison to the second layer, in particular a weight per surface area that is 1.2 times smaller. As a whole, the first layer serves only for supporting the second layer which can take on the actual task of particle separation from the water. However, especially also on the larger surfaces of a mesh or other support structures, microbes may adhere and spread, for which reason these structures are also provided with the at least one at least antibacterial agent.

A further aspect of the invention concerns a filter element that is embodied as a round filter element or flat filter element. The filter element comprises a filter media pack of the filter medium according to the invention. The filter media pack can be in particular a folded filter media pack that may be star-folded for formation of a cylindrical filter element. Preferably, the filter element is a water filter element of a water injection system for an internal combustion engine or gas turbine.

In particular, the filter element can comprise at least one end disc that is connected with the filter media pack by material fusion, for example, can be welded thereto. The filter element can also comprise two end discs, for example, a closed and an open end disc or two open end discs, wherein the filter element design depends on the fluid system intended for use. Additional filter configurations are known to a person of skill in the art.

A further aspect of the invention concerns a use of the filter element in a prefilter and/or a main filter of the fluid conduit of a water injection system of an internal combustion engine and/or a gas turbine.

Particularly preferred, the prefilter as well as the main filter, i.e., two different locations of the water injection system, can comprise a filter element according to the invention so that there is no threat of a biofilm formation at the prefilter or at the main filter. By a two-stage filtration, the injection nozzles and/or valves of the water injection system can be protected even more reliably from contamination.

Moreover, the prefilter may comprise a housing and a filter element arranged in the housing.

A method according to the invention for producing the filter element comprises the steps of providing the individual layers, individually coating and/or individually impregnating each layer with the active agent, in particular a zinc pyrithione solution, and subsequently joining the layers to the filter medium.

For coating or impregnation of the layers, the padding process with subsequent drying can be employed, wherein drying can be performed at room temperature or at elevated temperature, for example, 100° C. or more.

When performing the padding process, an aqueous solution can be used in which the active agent is dissolved. In addition, the solution may comprise the aforementioned polyacrylates which are contained therein as finest particles or powder and improve adherence of the active agent at the layers/fibers.

A last aspect of the invention concerns a water injection system for an internal combustion engine with a water tank and at least one injection device, for example, with one or a plurality of injection nozzles or valves. The injection device is connected in fluid communication with the water tank wherein in a fluid conduit between the water tank and the at least one injection device at least one filter element is provided which is a filter element according to the invention. In this way, the problem of biofilm formation by growth of microorganisms, which is a great problem especially in aqueous media, can be effectively counteracted.

In the following, the invention will be explained in more detail based on an embodiment with the aid of the attached figures.

### BRIEF DESCRIPTION OF THE DRAWINGS

FIG. 1 shows a schematic and simplified circuit diagram of the fluid conduit in a commercial vehicle.

FIG. 2 shows a schematic configuration of a first filter medium.

FIG. 3 shows a schematic configuration of a second filter medium.

### DESCRIPTION OF PREFERRED EMBODIMENTS

The Figures show only examples and are not to be understood as limiting.

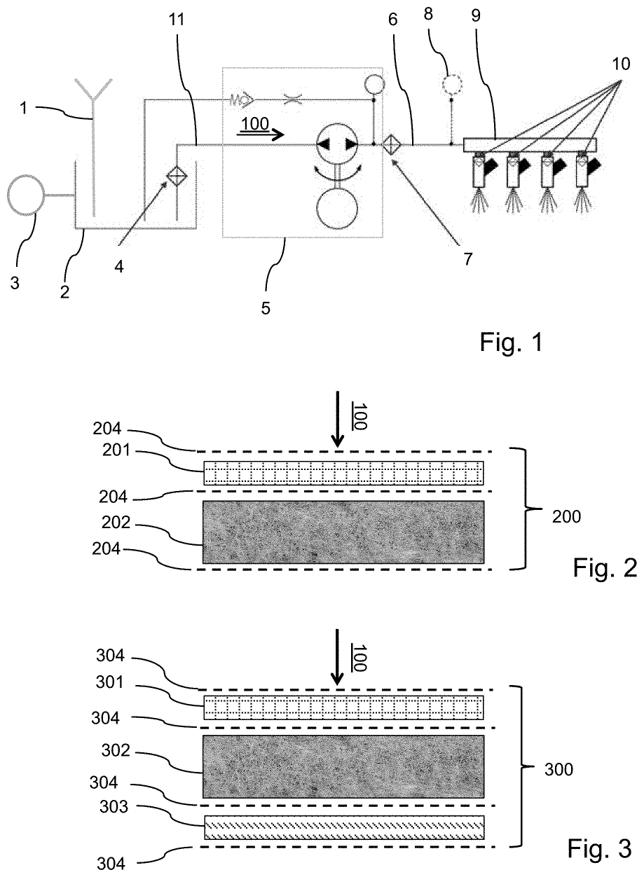

FIG. 1 shows in a simplified manner the configuration of a medium conduit of a water injection system of an internal combustion engine with a fluid flow of water in flow direction 100. One can see a heated water tank 2 with a refill socket 1 and a sensor 3 for determining the water quality, the filling level, and/or the temperature.

The water tank 2 comprises a first supply line 11 to a pump module 5 arranged downstream of the water tank in flow direction 100. The pump module 5, as illustrated in FIG. 1, can be provided with a shut-off valve, an orifice plate, a check valve, a pressure sensor, and an optional heater.

In order to protect the pump module from contaminations from the water tank, the supply line 11 comprises a prefilter 4. It filters dirt particles of a magnitude of greater than 25 μm from the fluid flow.

A second supply line 6 conducts the fluid further to a nozzle arrangement 9 which is arranged downstream of the pump module 5 in flow direction 100. Through the nozzles 10 of the nozzle arrangement 9, the injection of water into a piston engine or a gas turbine of the internal combustion engine can be performed. Optionally, the medium pressure upon supply of the medium into the nozzle arrangement 9 can be monitored by a pressure sensor 8.

The second supply line 6 comprises a main filter 7 which protects the nozzle arrangement 9 from clogging or soiling. The main filter 7 is also often described as a fine filter. It serves for filtration of particles with a particle size greater than 9 μm from the fluid flow.

The maximum loading of the prefilter 4 and of the fine filter 7 amounts to preferably at least 10 grams, preferably at least 12 grams.

The pressure drop of the prefilter 4 in flow direction 100 amounts to preferably maximally 100 mbar at a flow rate of 110 l/h.

The pressure drop of the fine filter or main filter 7 amounts to preferably maximally 500 mbar at a flow rate of 80 l/h.

FIG. 2 shows the configuration of a filter medium 200 according to the invention for use in a prefilter 4 and/or main filter 7.

The filter medium 200 comprises at least a first layer 201 and at least a second layer 202.

The first layer 201 of the filter medium 200 is in this context the inflow-side layer, as can be seen in FIG. 2 based on the flow direction 100.

The first layer 201 is a support layer and can be embodied as a nonwoven layer or as a mesh layer. The predominant number of fibers of the first layer 201 are made of a synthetic plastic material. In case of a nonwoven layer, they can be, as an example and preferred, PBT fibers (polybutylene terephthalate fibers). Alternatively, the mesh can be embodied on the basis of PBT. The first layer 201 can comprise a weight per surface area of less than 130 g/m², in particular between 70-110 g/m². The average thickness of the second layer 202 can amount to in particular less than 0.7 mm, in particular between 0.4 to 0.6 mm.

The second layer 202 is a filtration layer and is embodied as a nonwoven layer. The predominant number of fibers of the second layer can be advantageously PET fibers in this context. The second layer 202 can have a weight per surface area of more than 140 g/m², in particular between 160-180 g/m². The average thickness of the second layer 202 can amount to more than 0.8 mm, in particular between 0.9 to 1.2 mm. The average fiber diameter amounts to 4 to 40 μm. The data in regard to the thickness and the fiber diameter can be determined microscopically.

The filter medium 200 can be provided zigzag-folded in a filter element. The filter medium 200 can be arranged in the filter element as a hollow cylindrical folded bellows with star-shaped cross section. The folded bellows is delimited at each of its two terminal end faces by an end disc, respectively. A filter element of the afore described type is disclosed, for example, in DE 10 2016 008 502 A1 which is incorporated by reference in its entirety in the context of the present invention in particular with regard to the configuration of the filter element.

According to the invention, the first layer 201 as well as the second layer 202 comprise an at least antibacterial agent which is zinc pyrithione according to this exemplary embodiment.

The active agent, here zinc pyrithione, can be arranged in the form of a coating or impregnation 204 on the fibers of the first and second layers 201, 202 or penetrate the layers so that the layers are essentially impregnated with the active agent.

The exchange of the filter medium of the prefilter 4 in a water injection system can be performed every 15 years, for example.

FIG. 3 shows the configuration of a filter medium 300 for the main filter 7 which, of course, can be used also for the prefilter 4 in other applications.

The filter medium 300 is at least constructed of three layers with a first layer 301, a second layer 302, and a third layer 303.

The first layer 301 of the main filter 7 is an inflow-side layer. It can be embodied in analogy to the first layer 201 of the prefilter 4, in particular with respect to the weight per surface area and the thickness of the layer. It is embodied as a support layer and can be comprised of a mesh material and/or a nonwoven material. The fibers or the mesh structure of the first layer can be embodied to at least 80 wt.-% of PBT material.

The second layer 302 of the filter medium 300 is preferably embodied as a fine filter. It can be a nonwoven layer of meltblown fibers. The predominant number of meltblown fibers can be embodied in particular as PBT fibers. In comparison to cellulose fibers, PBT meltblown fibers have a dust storage capacity that is more than four times higher under analogous measuring conditions.

The second layer 302 can comprises a weight per surface area of more than 130 g/m², in particular between 140-180 g/m². The average thickness of the second layer 302 can amount to more than 0.8 mm, in particular between 0.9 to 1.1 mm. The average fiber diameter amounts to 0.1 to 10 μm. The data with respect to the thickness and the fiber diameter can be determined microscopically.

The third outflow-side layer 303 can also be embodied as a support layer, namely as a nonwoven layer. This layer 303 can be embodied in particular as a spunbond layer. The spunbond layer comprises a reduced layer thickness, preferably a layer thickness that is at least reduced by 1.5 times compared to the first and second layers 301 and 302 arranged above. At least up to 80% PET fibers can be utilized as spunbond fiber material. The outflow-side layer 303 can be embodied also as a support layer in this context. The spunbond layer enables, on the one hand, drainage and imparts to the filter medium 300 overall a higher stiffness.

The zinc pyrithione coating or impregnation is schematically illustrated in FIG. 3 and identified by a reference character 304.

The entity of the filter medium 300 as a main filter 7 comprises an initial degree of separation, determined by particle count according to ISO 19438:2003-11, of more than 99.5% for particles of a particle size of greater than 10 μm. The entity of the filter medium 300 of the main filter 7 comprises a dust storage capacity of 100 g/m² at 300 mbar for loading with an air flow with 50 mg/l dust and at an inflow distribution of 0.16 l/cm²h according to ISO-19438:2003-11.

The high dust storage capacity enables exchange of the filter at an exchange interval of more than two years or more in a commercial vehicle.

The filter medium 300 of the main filter, in analogy to filter medium 200 of the prefilter, can be arranged in a filter element or alternatively arranged, folded or unfolded, in a planar frame structure in a flat filter element.

The air permeability of the filter medium 200 of the prefilter 4 according to ASTM D 737 is preferably at least three times as large as the air permeability of the filter medium 300 of the main filter 7.

In this context, the air permeability of the filter medium 200 of the prefilter 4 at 200 Pa can amount to between 150 to 250 l/m²/s, wherein the air permeability of the filter medium decreases minimally in comparison to a filter medium with analogous configuration and under analogous measuring conditions but with uncoated and/or non-impregnated layers.

The thickness of the filter medium 200 of the prefilter 4 amounts to preferably 0.25 to 0.4 mm at a pressure of 0.5 kPa.

In this context, the air permeability of the filter medium 300 of the main filter 7 at 200 Pa can amount to between 500 to 850 l/m²/s, wherein the air permeability of the filter medium increases minimally in comparison to a filter medium with analogous configuration and under analogous measuring conditions but with uncoated and/or non-impregnated layers.

The thickness of the filter medium 200 of the prefilter 4 amounts to preferably 0.8 to 2.0 mm at a pressure of 0.5 kPa.

In the following, a method for producing the filter media 200 and 300 according to the invention of the prefilter 4 and of the main filter 7 will be described in more detail.

The coating or impregnation is applied in the context of a padding method, also known as full bath impregnation, to the fibers of the layers.

In the context of a wet treatment, the layers are initially passed through a bath with impregnation or coating agent. In this bath, the so-called liquor which comprises the zinc pyrithione is arranged. The bath temperature can amount to preferably 40-60° C. and the exposure time approximately 20 to 30 min.

In a roll press, the filter medium can be squeezed.

Subsequently, a drying process or a condensation process of the filter medium 200, 300 can be performed.

The drying process can be performed at 120° C. and the condensation process at 140° C., for about 2 minutes, respectively.

The liquor comprises also water and a hydrophobic binding agent system, preferably based on polyacrylate, which binds the zinc pyrithione to the fibers of the respective layers.

The layers are preferably individually impregnated and/or coated during manufacture and then laid on top of each other for providing the filter medium according to the invention.

The concentration of the zinc pyrithione in the liquor can amount to preferably 5 g/l to 20 g/l. The concentration of the zinc pyrithione per kg of nonwoven material can amount to preferably at least 2 g, particularly preferred 4 g-20 g.

A storage in water at 65° C. for 168 h and a conductivity measurement showed that the conductivity of the water increased. This is an indication that some quantities of zinc pyrithione had been washed out. For long service lives, the slow washout of zinc pyrithione is advantageous because water in the water tank and in the conduits will be disinfected due to wash-out or the growth of germs will at least be reduced.

The electrical conductivity of the solution should be less than 200 μS.

The antibacterial activity of the filter media 200 and 300 were determined according to the testing method AATCC 100:2012. In this context, the filter medium was exposed to bacteria at 37° C. for 20 h. Staphylococcus aureus (according to ATCC 6528) and Escherichia coli (according to ATCC 11 229) were used as testing germ. Filter media exclusively with PBT fibers showed an antibacterial activity of more than 99.4%, in particular of 99.4 to 99.99%, relative to both germs.

Furthermore, the fungicidal activity in the form of the so-called mildew resistance test (AATCC 30-III—2013) was determined. Aspergillus niber (ATCC 6275) and Chaetomium globosum (ATCC 6205) were utilized as testing fungus. The incubation time was 7 days at 28° C. and more than 90% moisture. The impregnated filter media showed no growth in the test.

As a result, the antibacterial and the fungicidal test demonstrated excellent results for the action of the filter media 200 and 300.

The layers of the prefilter and of the main filter have been always described in the examples with PBT fibers or PET fibers. Alternatively, the layers can also comprise polyamide fibers or polypropylene fibers.

The filter media are resistant across a wide pH value range, in particular however in a pH value range between pH=0.6 to pH=9.

What is claimed is:

1. A filter medium comprising:
a first layer as a support layer and a second layer as a filtration layer arranged downstream of the first layer;
the first layer and the second layer both comprising at least one active agent that is at least antibacterial.

2. The filter medium according to claim 1, wherein the at least one active agent is selected from the group consisting of pyrithione, a metal salt of pyrithione, a pyrithione derivative, a metal salt of a pyrithione derivative, and a quaternary ammonium salt of the general formula NR₄⁺X⁻ or R═NR₂⁺X⁻.

3. The filter medium according to claim 2, wherein the metal salt of pyrithione is an alkali metal salt, an alkaline earth metal salt, or a transition metal salt.

4. The filter medium according to claim 3, wherein the alkali metal salt is a sodium salt and wherein the transition metal of the transition metal salt is selected from the group consisting of zinc, manganese, copper, and iron.

5. The filter medium according to claim 2, wherein the metal salt of a pyrithione derivative is an alkali metal salt, an alkaline earth metal salt, or a transition metal salt.

6. The filter medium according to claim 5, wherein the alkali metal salt is a sodium salt and wherein the transition metal of the transition metal salt is selected from the group consisting of zinc, manganese, copper, and iron.

7. The filter medium according to claim 2, wherein, in the general formula NR₄⁺X⁻ or R═NR₂⁺X⁻, R is an organic residue and is the same or different.

8. The filter medium according to claim 7, wherein R is selected from the group consisting of an alkoxy group of the general formula —OCH₃, a siloxy group of the general formula R₃Si—O—, and an alkoxysilyl group of the general formula R¹R²R³Si—O—R⁴.

9. The filter medium according to claim 8, wherein R¹R²R³Si—O—R⁴ is a trialkoxysilylpropyl group.

10. The filter medium according to claim 9, wherein the quaternary ammonium salt is dimethyltetradecyl [3-(trimethoxsilyl)propyl] ammonium chloride or 3-(tri-methoxysilyl) propyldimethyl octadecyl ammonium chloride.

11. The filter medium according to claim 2, wherein the metal salt of pyrithione or the metal salt of a pyrithione derivative is a zinc salt.

12. The filter medium according to claim 2, wherein the metal salt of pyrithione is zinc pyrithione.

13. The filter medium according to claim 1, wherein the first layer and the second layer each are provided with an impregnation containing the at least one active agent and/or a coating containing the at least one active agent.

14. The filter medium according to claim 13, wherein the impregnation containing the at least one active agent and/or the coating containing the at least one active agent comprises a binding agent based on polyacrylate.

15. The filter medium according to claim 14, wherein the at least one active agent is zinc pyrithione.

16. The filter medium according to claim 15, wherein a ratio of a concentration of zinc pyrithione to a concentration of the binding agent in the impregnation containing the at least one active agent and/or the coating containing the at least one active agent is selected such that at least 0.1 wt.-% of zinc pyrithione is washed out of the coating containing the at least one active agent and/or of the impregnation containing the at least one active agent after 168 h in water at 65° C.

17. The filter medium according to claim 1, wherein the second layer is a nonwoven layer and comprises to at least 80 wt.-% synthetic fibers.

18. The filter medium according to claim 17, wherein the synthetic fibers are selected from one or more of the fibers of the group consisting of copolymer fibers, PET fibers, PBT fibers, PA fibers, PP fibers, and PE fibers.

19. The filter medium according to claim 18, wherein the synthetic fibers are meltblown fibers and/or staple fibers.

20. The filter medium according to claim 1, wherein an air permeability of the filter medium amounts to 100 to 850 l/m²s.

21. The filter medium according to claim 1, wherein the first layer comprises a mesh structure.

22. The filter medium according to claim 21, wherein the mesh structure has a thickness of less than 0.8 mm.

23. The filter medium according to claim 1, wherein the first layer comprises at least 80 wt.-% synthetic fibers.

24. The filter medium according to claim 23, wherein the synthetic fibers are selected from one or more of the fibers of the group consisting of copolymer fibers, PET fibers, PBT fibers, PA fibers, PP fibers, and PE fibers.

25. The filter medium according to claim 1, wherein the filter medium comprises a third layer arranged at an outflow side of the second layer, wherein the third layer is a support layer, wherein the first layer, the second layer, and the third layer each are provided with an impregnation containing the at least one active agent and/or a coating containing the at least one active agent.

26. The filter medium according to claim 1, wherein the first layer comprises a thickness that is reduced in comparison to a thickness of the second layer.

27. The filter medium according to claim 26, wherein the thickness of the first layer is reduced by at least 1.5 times compared to the thickness of the second layer.

28. The filter medium according to claim 1, wherein the first layer comprises a weight per surface area that is reduced in comparison to a weight per surface area of the second layer.

29. The filter medium according to claim 28, wherein the weight per surface area of the first layer is reduced by at least 1.2 times compared the weight per surface area of the second layer.

30. A filter element that comprises a filter media pack comprising a filter medium according to claim 1.

31. The filter element according to claim 30, wherein the filter media pack is a folded filter media pack and wherein the filter element is a round filter element or a flat filter element.

32. The filter element according to claim 30, further comprising at least one end disc connected by material fusion to the filter media pack.

33. The filter element according to claim 30 as a prefilter or a main filter in a fluid conduit of a water injection system of an internal combustion engine or of a gas turbine.

34. A method for producing a filter medium according to claim 1, comprising:
providing individually the first layer, the second layer, and an optional third layer;
individually coating or impregnating the first layer, the second layer, and the optional third layer with the at least one active agent; and
subsequently joining the first layer, the second layer, and the optional third layer to the filter medium.

35. The method according to claim 34, selecting a zinc pyrithione solution as the at least one active agent.

36. The method according to claim 34, performing coating or impregnating by a padding process.

37. A water injection system for an internal combustion engine, the water injection system comprising a water tank, at least one injection device, a fluid conduit connecting in fluid communication the water tank to the at least one injection device, wherein in the fluid conduit between the water tank and the at least one injection device at least one filter element is arranged, wherein the at least one filter element comprises a filter media pack comprising a filter medium according to claim 1.
